(19) United States
(12) Patent Application Publication
(10) Pub. No.: US 2003/0198429 A1
(43) Pub. Date: Oct. 23, 2003

(54) Image projection apparatus

(75) Inventor: Sang-Whoe Dho, Suwon-City (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/411,244

(22) Filed: Apr. 11, 2003

(30) Foreign Application Priority Data
Apr. 23, 2002 (KR) 2002-22308

(51) Int. Cl. G02B 6/26; G02B 6/42

(52) U.S. Cl. 385/18

(57) ABSTRACT

An image projection apparatus includes a light source for emitting a plurality of monochromatic laser beams of different wavelengths; a first light transmit unit comprising a plurality of optical fibers for passing the respective monochromatic laser beams therethrough; a light switch unit having a plurality of reflection mirrors for selectively deflecting the respective monochromatic laser beams at a predetermined angle; a plurality of quadrangular bean generating units for converting the deflected monochromatic laser beams into quadrangular beams, each of which having a predetermined ratio of width to height; a plurality of panels for receiving the quadrangular beam-converted monochromatic laser beams and forming monochromatic images corresponding to the monochromatic color laser beams; and a plurality of projection lenses disposed opposite to the plurality of panels. Accordingly, by using the light switches and 3 single-plate panels, a plurality of different images are simultaneously realized and the utilization efficiency of the light can be improved.

### BACKGROUND OF THE INVENTION

1. Field of the Invention

The present invention relates to an image projection apparatus, and more particularly, to an image projection apparatus for respectively forming images on a plurality of screens by using light switches arranged in a structure of a square matrix. The present application is based on Korean Patent Application No. 2002-22308, which is incorporated herein by reference.

2. Description of the Prior Art

Projectors and projection systems are display devices that display an image by projecting an inputted image signal onto a screen. Such a display device is used to aid in a presentation at a meeting, or used in places such as a theater or home.

A conventional method used to realize a wide vision in the display device has been to magnify an image appearing on a Liquid Crystal Display (LCD) or a Cathode Ray Tube (CRT) with a lens and then project the image onto a screen. However although the conventional method may be strong in achieving the wide vision, it is relatively weak in guaranteeing clear image quality. In order to solve this problem, an image projection apparatus employing a Digital Micromirror Device (DMD) panel has been suggested.

The DMD is a semiconductor light switch using a micro drive mirror, i.e. a micromirror. This micromirror controls deflection of light according to an inputted image signal. In the DMD according to a digital method, a clean image can be realized. Also, since there is no loss of light that is caused by a polarizing filter, the DMD can obtain a large amount of light output.

FIG. 1 is a view showing a basic structure of a conventional image projection apparatus using a color wheel.

Referring to FIG. 1, the conventional image projection apparatus 100 using a color wheel comprises a light source 110, a color wheel 120, a DMD panel 130, and a projection lens 140. A light path of white light is indicated by one-dotted line in FIG. 1.

The light source 110 emits white light using an arc lamp or a laser beam. The color wheel 120 is rotated by a rotation driver in the direction indicated by the arrows in FIG. 1, and has R (red), G (green), and B (blue) regions.

The white light emitted from the light source 110 is subdivided into R, G, B beams by the RGB regions.

The DMD panel 130 comprises a plurality of micromirrors 130a. The R, G, B beams divided according to their wavelengths are projected onto the DMD panel 130 and then deflected from the micromirrors 130a. The deflected R, G, B beams penetrate the projection lens 140 and are formed on the screen as an image.

The conventional image projection apparatus 100 can obtain an excellent quality of the color image due to the presence of the individually operated micromirrors 130a. However, in the case that a color filter such as the color wheel 120 and the DMD panel 130 are used to form an image, the DMD panel 130 uses only ⅓ the amount of the white light emitted from the light source 110.

For example, with respect to the R region of the color wheel 120, the R beam penetrates the color wheel 120, while the G and B beams are blocked by the color filter and discarded. This phenomenon also occurs with respect to the G and B beams.

Accordingly, since only ⅓ the amount of the incident white light is used in the color filtering method, the brightness of the image is reduced to ⅓. That is, since the amount of white light emitted from the light source 100 is reduced while penetrating the color wheel 120, light efficiency deteriorates and optimal brightness of the image cannot be obtained. Also, there may occur an occasion that boundary lines for separating regions of one panel onto which the R, G, B beams are projected respectively, are overlapped.

### SUMMARY OF THE INVENTION

The present invention has been developed in order to solve the above problems in the prior art. Accordingly, an object of the present invention is to provide an image projection apparatus capable of enhancing the utilization of light that is decreased to 1/3 at one panel by using a high reflective mirror, and removing the phenomenon in which the boundary lines of the respective beam regions are overlapped.

The above object is achieved by providing an image projection apparatus comprising: a light source for emitting a plurality of monochromatic laser beams of different wavelengths; a first light transmit unit comprising a plurality of optical fibers for passing the respective monochromatic laser beams therethrough; a light switch unit having a plurality of reflection mirrors for selectively deflecting the respective monochromatic laser beams at a predetermined angle; a plurality of quadrangular beam generating units for converting the deflected monochromatic laser beams into quadrangular beams, each of which having a predetermined ratio of width to height; a plurality of panels for receiving the quadrangular beam-converted monochromatic laser beams and forming monochromatic images corresponding to the monochromatic color laser beams; and a plurality of projection lenses disposed opposite to the plurality of panels.

More specifically, the light switch unit has the plurality of reflection mirrors arranged in a matrix structure of (n×n), where n is a positive number equal to or greater than 3. A position of each reflection mirror oscillates between a first position and a second position, the first position for allowing the monochromatic laser beams to be deflected, the second position for allowing the monochromatic laser beams to go straightly. The light switch unit is operated such that only one reflection mirror per one row and one column is positioned at the first position.

Also, each of the (n×n) reflection mirrors deflects the monochromatic laser beams at least one time according to a predetermined order such that one image is formed on the panels.

The light switch unit comprises a plurality of output ports disposed at an output end thereof, for outputting the monochromatic laser beams therethrough. The monochromatic laser beams deflected from a first mirror among the plurality of reflection mirrors are output through an output port corresponding to the first mirror.

The image projection apparatus further comprises a second light transmit unit comprising a plurality of optical fibers for transmitting the monochromatic laser beams output from the output ports to the quadrangular beam generating units. The panels are digital micromirror devices (DMD) for digitalizing the monochromatic images and deflecting the images at a predetermined angle using the projection lenses.

According to the present invention, at least one signal among the RGB signals is input to the plurality of panels in a predetermined order by using the light switches arranged in the (3×3) matrix structure such that a plurality of different or same images are realized.

### BRIEF DESCRIPTION OF THE DRAWINGS

The above object and features of the present invention become more apparent by describing a preferred embodiment of the present invention with reference to the accompanying drawings, in which:

FIG. 1 is a view showing a basic structure of a conventional image projection apparatus using a color wheel;

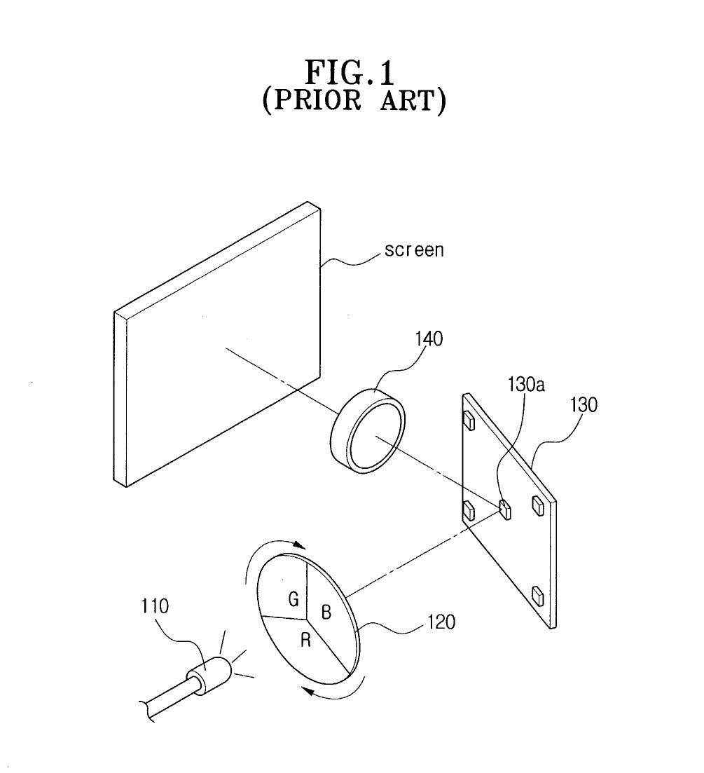

FIG. 2 is a view showing a basic structure of an image projection apparatus according to a preferred embodiment of the present invention;

FIG. 3 is a view showing a basic structure of light switches employed in the image projection apparatus of FIG. 2;

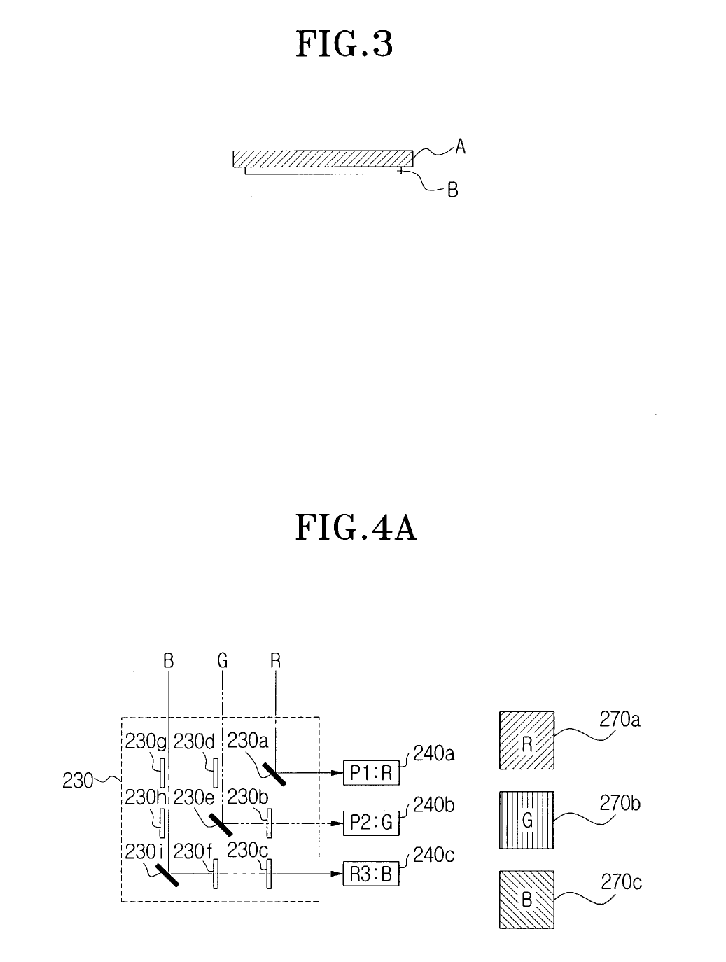

FIGS. 4A through 4C are views showing images formed as the light switches are manipulated by a predetermined order according to the present invention.

### DETAILED DESCRIPTION OF THE PREFERRED EMBODIMENT

Hereinafter, the present invention will be described in greater detail with reference to the accompanying drawings.

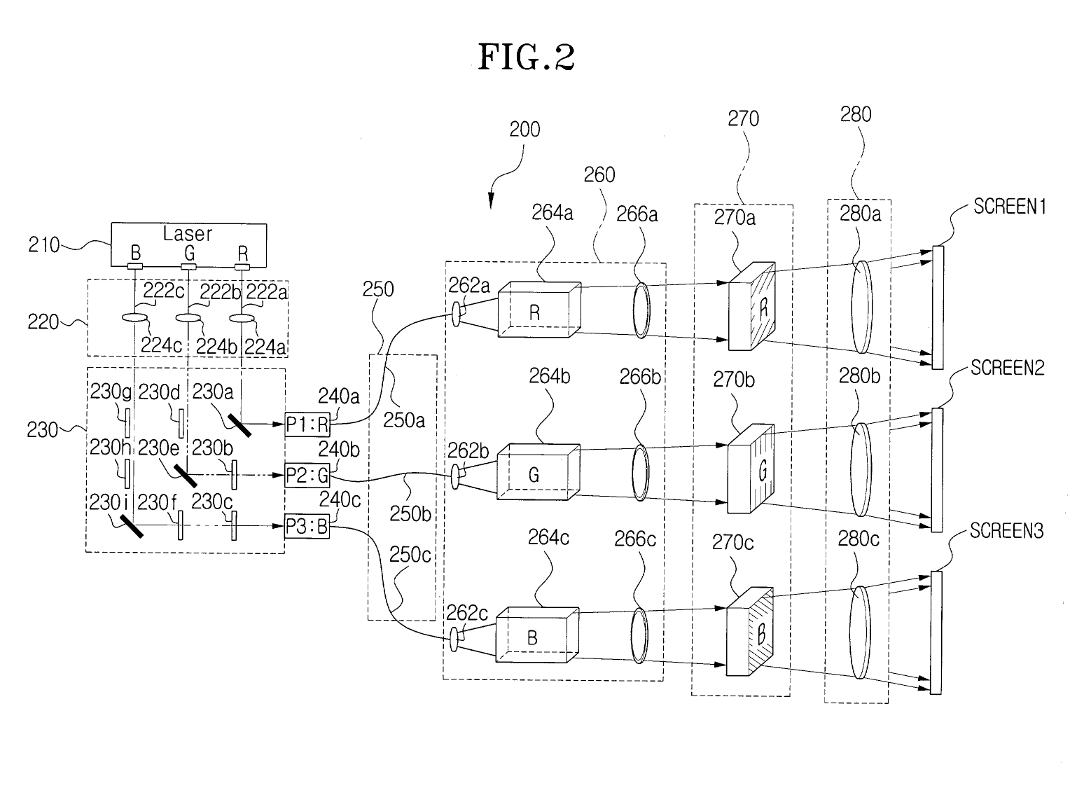

FIG. 2 is a view showing a basic structure of an image projection apparatus according to a preferred embodiment of the present invention.

Referring to FIG. 2, an image projection apparatus 200 according to the present invention comprises a light source 210, a first light transmit unit 220, a light switch unit 230, output ports 240a, 240b, and 240c, a second light transmit unit 250, a quadrangular beam generating unit 260, a panel unit 270 and a projection lens unit 280.

Hereinbelow, the image projection apparatus 200 having light switches arranged in the square matrix structure of (3×3) will be explained by way of an example. Also, light paths of red (R), green (G), and blue (B) laser beams in the light switch unit 230 are respectively illustrated by a single-dashed line, a double-dashed line and a triple-dashed line.

The light source 210 emits a plurality of monochromatic beams having different wavelengths. The light source 210 may use one or more devices such as a laser, an arc lamp, a metal halide lamp, a halogen lamp, a xenon lamp, etc. In this embodiment, a laser is used by way of an example. The plurality of the monochromatic beams (hereinafter called ‘laser beams’) are red (R), green (G), and blue (B) laser beams.

The first light transmit unit 220 has a plurality of first optical fibers 222a, 222b, and 222c and a plurality of first collimating lenses 224a, 224b, and 224c. The first optical fibers 222a, 222b, and 222c transmit the respective R, G, B laser beams to the first collimating lenses 224a, 224b, and 224c.

The first collimating lenses 224a, 224b, and 224c are respectively disposed at output ends of the first optical fibers 222a, 222b, and 222c. The first collimating lenses 224a, 224b, and 224c concentrate the R, G, B. laser beams transmitted from the optical fibers 222a, 222b, and 222c into the light switch unit 230.

The light switch unit 230 comprises a plurality of light switches for deflecting the R, G, B laser beams at a predetermined angle or passing the R, G, B laser beams therethrough. The light switch unit 230 has a matrix structure of (n×n), where n is a positive number equal to or greater than 3.

Accordingly, the light switch unit 230 has light switches 230a through 230i as many as (n×n).

In this embodiment, the light switch unit 230 has 9 light switches 230a through 230i arranged in the structure of a square matrix (3×3).

The light switches 230a through 230i use high reflective mirrors that utilize a micro electro mechanical system (MEMS) technology. The light switches 230a through 230i directly output the R, G, B laser beams; i.e., the light switches 230a through 230i output optical signals without converting an input optical signal to an electrical signal. Accordingly, a switching (on or off) speed becomes faster than a switching speed in the conventional art that requires the process of converting an optical signal to an electrical signal.

Each of the light switches 230a through 230i has a reflection mirror A and a drive unit B. The reflection mirror A has a high reflective mirror formed on a side thereof, for deflecting the laser beams, and is fabricated by utilizing the MEMS technology.

The position of the reflection mirror A oscillates between a first position (on-position) and a second position (off-position). The first position allows any one of the R, G, B laser beams inputted to the light switches 230a through 230i to be deflected to any one panel of the DMD panel unit 270 comprising a plurality of panels, while the second position allows the R, G, B laser beams to go straight.

That is, the first position (on-position) is the state where the light switches 230a through 230i are inclined, (for example, the light switches 230a, 230e, and 230i at the first position are illustrated as black bars in FIG. 2), and allows the laser beams inputted to the light switches 230a through 230i to be deflected to the corresponding output ports 240a, 240b, and 240c. The laser beams deflected from the light switches 230a through 230i at the first position (on-position) are used to form an image.

The second position (off-position) is the state where the light switches 230a through 230i are in parallel relation to the direction of the laser beams inputted to the light switches 230a through 230i and the inputted laser beams go straight. (For example, the light switches 230b, 230c, 230d, 230f, 230g, and 230h at the second position are illustrated as white bars in FIG. 2.)

Also, the light switch unit 230 is operated such that only one light switch is positioned at the first position (on-position) per one row and one column. The light switch unit 230 is operated such that 3 light switches are simultaneously positioned at the first position (on-position) or the (3×3) light switches 230a through 230i are positioned at the first position by a predetermined order.

For example, if a predetermined light switch 230a is positioned at the first position (on-position), the light switches 230b, 230c, 230d, and 230g arranged in the same row and column of the light switch 230a are positioned at the second position (off-position). At this time, if a predetermined light switch 230e is positioned at the first position (on-position), the light switch unit 230 is operated to position another predetermined light switch 230i at the first position (on-position).

Also, one image is formed when each of (3×3) light switches 230a through 230i is positioned at the first position (on-position) at least one time.

An output end of the light switch unit 230 comprises the plurality of output ports 240a, 240b, and 240c. The output ports 240a, 240b, and 240c transmit the laser beams deflected from the light switches 230a through 230i to the second light transmit unit 250.

The second light transmits unit 250 has a plurality of second optical fibers 250a, 250b, and 250c. At the input ends of the second optical fibers 250a, 250b, and 250c, i.e., the output ends of the output ports 240a, 240b, and 240c, a plurality of second collimating lenses (not shown) can be provided.

The second collimating lenses (not shown) concentrate the R, G, B laser beams inputted from the output ports 240a, 240b, 240c to the respective second optical fibers 250a, 250b, 250c. The R, G, B laser beams concentrated into the second optical fibers 250a, 250c, and 250c are respectively transmitted to the quadrangular beam generating unit 260.

The quadrangular beam generating unit 260 is disposed at output ends of the second optical fibers 250a, 250b, and 250c, and converts the transmitted R, G, B laser beams to quadrangular beams, each of which having a predetermined ratio of width to height. The quadrangular beam generating unit 260 has a plurality of first lenses 262a, 262b, and 262c, a plurality of light tubes 264a, 264b, and 264c, and a plurality of second lenses 266a, 266b, and 266c.

The plurality of first lenses 262a, 262b, and 262c disperse the respective R, G, B laser beams and make the laser beams incident into the light tubes 264a, 264b, and 264c.

Each of the plurality of light tubes 264a, 264b, and 264c is shaped in a cube and has a passage hole formed therein. Four internal sides of each of the light tubes 264a, 264b, and 264c are mirrored. When the laser beams dispersed from the first lenses 262a, 262b, and 262c are projected into the passage holes of the light tubes 264a, 264b, and 264c, the laser beams are converted into the quadrangular beams.

The plurality of second lenses 266a, 266b, and 266c disperse the quadrangular beam-converted laser beams such that the beams are incident on the panel unit 270.

The panel unit 270 comprises one digital micromirror device (DMD) panel or one liquid crystal display (LCD) panel. The DMD panel is a reflection type panel, while the LCD panel is a penetration type panel. In the case of the LCD panel, the positions of projection lenses and a screen are variable. Hereinbelow, the description will be made about an embodiment of the present invention using the DMD panel.

The DMD panel unit 270 has a plurality of single-plate DMD panels. In this embodiment, the DMD panel unit 270 has 3 single-plate DMD panels 270a, 270b, and 270c.

The respective DMD panels 270a, 270b, and 270c receive the quadrangular beam-converted R, G, B laser beams, and form monochromatic images corresponding to the R, G, B laser beams on the entire DMD panels 270a, 270b, and 270c. The panel, on which the R laser beam is formed, is illustrated by oblique lines, the panel of the G laser beam by vertical lines, and the panel of B laser beam is illustrated by reverse-oblique lines.

For example, as shown in FIG. 2, the light switch 230a deflects the R laser beam, the light switch 230e the G laser beam, and the light switch 230i deflects the B laser beam. The R laser beam is projected onto the DMD panel 270a passing through the output port 240a, the second optical fiber 250a, the first lens 262, the light tube 264a, and the second lens 266a. The G and B laser beams are respectively projected on the DMD panels 270b and 270c.

Movable mirrors provided in the DMD panel unit 270 digitalize the R, G, B monochromatic images formed on the DMD panels 270a, 270b, and 270c and then deflect the image at a predetermined angle.

The images deflected from the movable mirrors of the DMD panel unit 270 are projected onto a plurality of screens SCREEN 1, SCREEN 2, and SCREEN 3, passing through the projection lens unit 280, thereby realizing an image. The projection lens unit 280 is disposed opposite to the respective DMD panels 270a, 270b, and 270c.

The plurality of screens SCREEN 1, SCREEN 2, and SCREEN 3 can have the same, or different size. When signals of the laser beams inputted to the respective screens SCREEN 1, SCREEN 2, and SCREEN 3 are different, the screens SCREEN 1, SCREEN 2, and SCREEN 3 simultaneously realize different images.

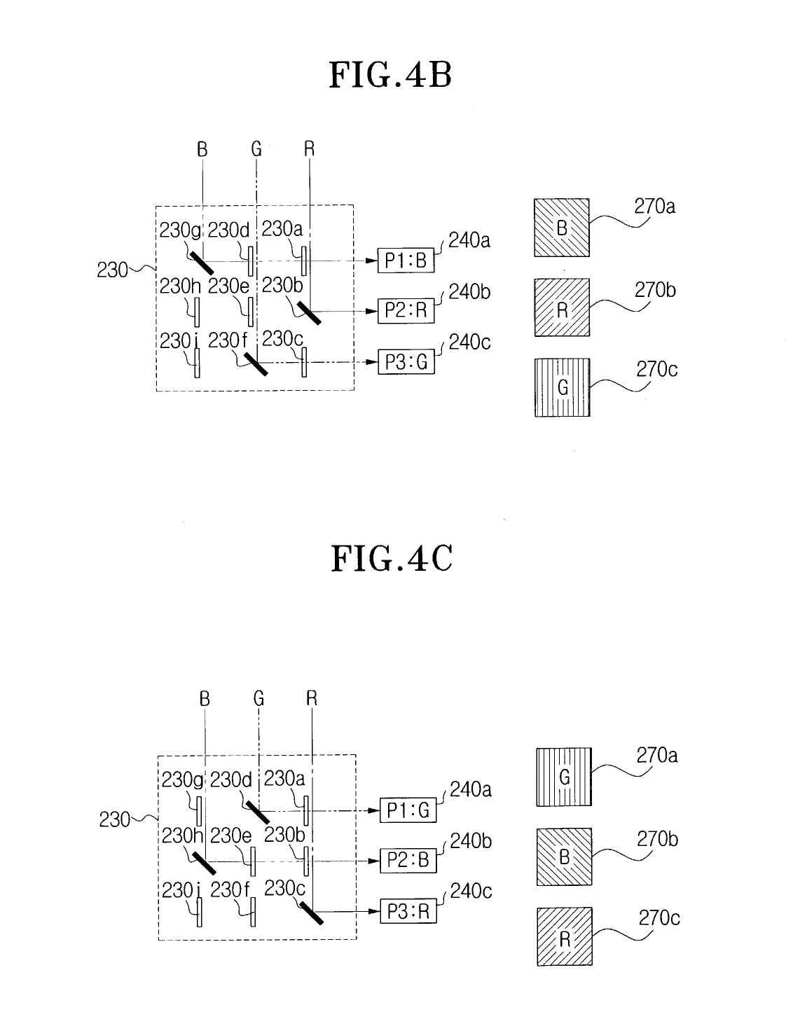

FIGS. 4A through 4C are views showing screens realized as the light switches are manipulated in a predetermined order according to the present invention. That is, one image is formed by the processes of FIGS. 4A, 4B and 4C. These processes are subject to change.

Referring to FIGS. 4A through 4C, the R, G, B laser beams are respectively projected onto any one of the light switches 230a through 230c arranged in the right column, any of the light switches 230d through 230f arranged in the middle column, and any one of the light switches 230g through 230i arranged in the left column.

Also, the laser beams deflected from the light switches 230a, 230d, and 230g of the first row form their respective monochromatic images on the DMD panel 270a through the output port 240a, the laser beams deflected from the light switches 230b, 230e, and 230h of the second row form their respective monochromatic images on the DMD panel 270b through the output port 240b, and the laser beams deflected from the light switches 230c, 230f, and 230i of the third row form their respective monochromatic images on the DMD panel 270c through the output port 240c.

In other words, the three monochromatic images formed on the plurality of DMD panels 270a, 270b, and 270c are formed by the manipulation of the light switch unit 230.

If the 9 light switches 230a through 230i of the light switch unit 230 are manipulated as shown in the following [table 1], color bars are formed on the respective DMD panels 270a, 270b, and 270c as shown in FIG. 4A.

TABLE 1

| | Port 1 | Port 2 | Port 3 |
|---|---|---|---|
| RED | 230a:ON | 230b:OFF | 230c:OFF |
| GREEN | 230d:OFF | 230e:ON | 230f:OFF |
| BLUE | 230g:OFF | 230h:OFF | 230i:ON |

In the [Table 1], RED indicates the R laser beam, GREEN indicates the G laser beam, and BLUE indicates the B laser beam, and Port 1, Port 2, and Port 3 respectively indicate the plurality of output ports 240a, 240b, and 240c.

Also, ON is the first position for deflecting the laser beams, OFF is the second position in which the laser beams go straight, and reference numerals 230a through 230i indicate the light switches.

P1: R in the FIG. 4A means that the R laser beam is input from the light switch 230a to the output port 240a. P2: G means that the G laser beam is input from the light switch 230e to the output port 240b, and P3:B means that the B laser beam is input from the light switch 230i to the output port 240c.

If the 9 light switches 230a through 230i of the light switch unit 230 are manipulated as shown in the following [Table 2], color bars are formed on the respective DMD panels 270a, 270b, and 270c as shown in FIG. 4B.

TABLE 2

| | Port 1 | Port 2 | Port 3 |
|---|---|---|---|
| RED | 230a:OFF | 230b:ON | 230c:OFF |
| GREEN | 230d:OFF | 230e:OFF | 230f:ON |
| BLUE | 230g:ON | 230h:OFF | 230i:OFF |

In the [Table 2,] RED indicates the R laser beam, GREEN indicates the G laser beam, and BLUE indicates the B laser beam, and Port 1, Port 2, and Port 3 respectively indicate the plurality of output ports 240a, 240b, and 240c. Also, ON is the first position for deflecting the laser beams, OFF is the second position in which the laser beams go straight, and reference numerals 230a through 230i indicate the light switches.

P1: B in the FIG. 4B means that the B laser beam is input from the light switch 230b to the output port 240b. P2: R means that the R laser beam is input from the light switch 230b to the output port 240b, and P3:G means that the G laser beam is input from the light switch 230f to the output port 240c.

Also, if the 9 light switches 230a through 230i of the light switch unit 230 are manipulated as shown in the following [Table 3], color bars are formed on the respective DMD panels 270a, 270b, and 270c as shown in FIG. 4C.

TABLE 3

| | Port 1 | Port 2 | Port 3 |
|---|---|---|---|
| RED | 230a:OFF | 230b:OFF | 230c:ON |
| GREEN | 230d:ON | 230e:OFF | 230f:OFF |
| BLUE | 230g:OFF | 230h:ON | 230i:OFF |

In the [Table 3], RED indicates the R laser beam, GREEN indicates the G laser beam, and BLUE indicates the B laser beam, and Port 1, Port 2, and Port 3 respectively indicate the plurality of output ports 240a, 240b, and 240c.

Also, ON is the first position for deflecting the laser beams, OFF is the second position for going the laser beams straightly, and reference numerals 230a through 230i indicate the light switches.

P1: G in the FIG. 4C means that the G laser beam is input from the light switch 230d to the output port 240a. P2: B means that the B laser beam is input from the light switch 230h to the output port 240b, and P3: R means that the R laser beam is input from the light switch 230c to the output port 240c.

According to the present invention, the image projection apparatus consecutively projects the monochromatic laser beams onto the plurality of panels, i.e., 3 single-plate panels by using the light switches in which the MEMS technology is applied, thereby enhancing the utilization efficiency of the light used at the panels. This is accomplished by embodying the 3 single-plate panels system using the light switches and the optical fibers. Also, according to the image signals of the laser beams inputted to the respective DMD panels, different image are simultaneously formed on the plurality of screens.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An image projection apparatus comprising:
a light source for emitting a plurality of monochromatic laser beams of different wavelengths;
a first light transmit unit having a first plurality of optical fibers for passing the respective monochromatic laser beams therethrough;
a light switch unit having a plurality of reflection mirrors for selectively deflecting the respective monochromatic laser beams at a predetermined angle;
a plurality of quadrangular beam generating units for converting the deflected monochromatic laser beams into quadrangular beams, each of which has a predetermined ratio of width to height;
a plurality of panels for receiving the quadrangular beam-converted monochromatic laser beams and forming monochromatic images corresponding to the monochromatic color laser beams; and:
a plurality of projection lenses disposed opposite to the plurality of panels.

2. The image projection apparatus of claim 1, wherein the light switch unit has the plurality of reflection mirrors arranged in a square matrix of (n×n), where n is a positive number equal to or greater than 3.

3. The image projection apparatus of claim 1, wherein a position of each of the plurality of reflection mirrors oscillates between a first position and a second position, the first position for allowing the monochromatic laser beams to be deflected, the second position for allowing the monochromatic laser beams to go straight.

4. The image projection apparatus of claim 3, wherein the light switch unit has the plurality of reflection mirrors arranged in a square matrix and the light switch unit is operated such that only one reflection mirror per one row and one column of the matrix is positioned at the first position.

5. The image projection apparatus of claim 2, wherein each of the (n×n) reflection mirrors deflects the monochromatic laser beams at least one time according to a predetermined order.

6. The image projection apparatus of claim 1, wherein the reflection mirrors are micro electro mechanical system (MEMS) mirrors

7. The image projection apparatus of claim 1, wherein the light switch unit comprises a plurality of output ports disposed at an output end thereof, for outputting the monochromatic laser beams therethrough.

8. The image projection apparatus of claim 7, wherein the monochromatic laser beams deflected from a first mirror among the plurality of reflection mirrors are output through an output port corresponding to the first mirror.

9. The image projection apparatus of claim 7, further comprising a second light transmit unit comprising a second plurality of optical fibers for transmitting the monochromatic laser beams output from the output ports to the quadrangular beam generating units.

10. The image projection apparatus of claim 1, wherein the panels are digital micromirror devices (DMD) for digitalizing the monochromatic images and deflecting the images at a predetermined angle using the projection lenses.

11. An image projection apparatus comprising:
a light source which emits a plurality of light beams of different wavelengths;
a light switch unit having a plurality of reflection mirrors for selectively deflecting the respective light beams at a predetermined angle;
a plurality of panels for respectively receiving the deflected light beams and forming respective images corresponding to the light beams; and
a plurality of projection lenses disposed opposite to the plurality of panels which respectively project the respective images.

12. The image projection apparatus of claim 11, wherein the light switch unit has the plurality of reflection mirrors arranged in a square matrix of (n×n), where n is a positive number equal to or greater than 3.

13. The image projection apparatus of claim 11, wherein a position of each of the plurality of reflection mirrors oscillates between a first position and a second position, the first position for allowing the light beams to be deflected, the second position for allowing the light beams to go straight.

14. The image projection apparatus of claim 13, wherein the light switch unit has the plurality of reflection mirrors arranged in a square matrix and the light switch unit is operated such that only one reflection mirror per one row and one column of the matrix is positioned at the first position.

15. The image projection apparatus of claim 12, wherein each of the (n×n) reflection mirrors deflects the light beams at least one time according to a predetermined order.

16. The image projection apparatus of claim 11, wherein the reflection mirrors are micro electro mechanical system (MEMS) mirrors

17. The image projection apparatus of claim 11, wherein the light beams are monochromatic laser beams.

18. The image projection apparatus of claim 11, further comprising a plurality of quadrangular beam generating units for converting the deflected beams into quadrangular beams, each of which has a predetermined ratio of width to height, and transmitting the quadrangular beams to the plurality of panels.
